(19) United States
(12) Patent Application Publication
(10) Pub. No.: US 2026/0352108 A1
(43) Pub. Date: Nov. 5, 2026

(54) CONTROLLING A HYBRID COUPLED INDUCTOR-BASED VOLTAGE REGULATOR WITH ODD PHASE COUNT

(71) Applicant: Intel Corporation, Santa Clara, CA (US)

(72) Inventors: Wei DAI, Shanghai (CN); Xiaoguo LIANG, Shanghai (CN); Kaladhar RADHAKRISHNAN, Chandler, AZ (US); Horthense TAMDEM, Portland, OR (US); Jonathan DOUGLAS, Cave Creek, AZ (US)

(21) Appl. No.: 19/123,341

(22) PCT Filed: Nov. 22, 2022
(86) PCT No.: PCT/CN2022/133561

§ 371 Date: Apr. 22, 2025

(51) Int. Cl. H02M 1/00; H02M 3/00; H02M 3/155

(52) U.S. Cl. CPC H02M 1/0003; H02M 3/003; H02M 3/155

(57) ABSTRACT

A voltage regulator controller includes logic to generate a first set of control signals to control current in one or more coupled inductor pairs in a voltage regulator (VR) circuit, where the control signals for each coupled inductor pair operate at a first frequency representing a base operation frequency of each coupled inductor phase, and generate a second control signal at a second frequency to control current in an uncoupled inductor in the VR circuit, where the second frequency is set relative to the first frequency to control ripple in an output current of the VR circuit, and where the first set of control signals and the second control signal represent, in combination, an odd phase count. In embodiments, the second frequency is set based on the first frequency and on a number of coupled inductor pairs (N) in the VR circuit, e.g., 2N times the first frequency.

### TECHNICAL FIELD

Embodiments generally relate to computing systems. More particularly, embodiments relate to performance-enhanced technology for controlling voltage regulator circuits having hybrid coupled inductors with an odd phase count.

### BACKGROUND

Inductor and decoupling capacitor components account for a substantial portion (e.g., approximately 75% in some applications) of the real estate for current voltage regulator circuits in computing systems, including those in central processing unit (CPU) devices. Inversely coupled inductor (CL) pairing is a known technology providing certain advantages for voltage regulator circuits. Circuits using coupled inductors are designed at a granularity of two phases as one group; when more phases are required (e.g., additional CL pairs based on power or current output requirements), the phase count is scaled based on the number of additional pairs (e.g., phase counts range from 2, 4, 6, . . . etc.).

However, when power or current requirements are modest, the optimal total phase count can be a relatively small odd number (e.g., 3, 5 or 7 phases, etc.). Use of coupled inductor pairs alone results in an even number of phases, so to meet a modest power/current demand requires an excess capacity (e.g., 4 phases to meet a 3-phase demand), which results a waste of cost and space due to the excess CL components. While hybrid solutions (coupled plus uncoupled inductors) have been proposed, such solutions have proven impractical for computing system applications due to large output ripple currents and sizing requirements for the uncoupled inductor.

### BRIEF DESCRIPTION OF THE DRAWINGS

The various advantages of the embodiments will become apparent to one skilled in the art by reading the following specification and appended claims, and by referencing the following drawings, in which:

FIG. 1A provides a diagram illustrating an example of a controlled voltage regulator circuit according to one or more embodiments;

FIG. 1B provides a diagram illustrating an example of a coupled inductor pair according to one or more embodiments;

FIGS. 2A-2D provide diagrams illustrating examples of currents in a VR circuit according to one or more embodiments;

FIG. 3 provides a diagram illustrating a topology for an example controlled voltage regulator according to one or more embodiments;

FIGS. 4A-4F provide diagrams illustrating examples of topologies for a controlled voltage regulator and associated signal timing diagrams according to one or more embodiments;

FIG. 5 provides a flow diagram illustrating an example method for controlling a voltage regulator according to one or more embodiments;

FIG. 6 shows a block diagram illustrating an example performance-enhanced computing system having a controlled voltage regulator according to one or more embodiments;

FIG. 7 shows a block diagram illustrating an example semiconductor apparatus according to one or more embodiments;

FIG. 8 is a diagram of an example computing system according to one or more embodiments; and

FIG. 9 is a diagram of an example processor and/or system on chip according to one or more embodiments.

### DESCRIPTION OF EMBODIMENTS

Technology as described herein provides a unique control strategy for controlling a hybrid coupled inductor-based voltage regulator (e.g., having coupled and uncoupled inductors) with an odd phase count (e.g., phase count of 2N+1, where N represents the number of coupled inductor pairs). A voltage regulator is an electricity regulation device designed to automatically regulate an input voltage onto an output supply node. It can convert up (boost) or down (buck), and it can use techniques such as switching or linear regulation. Examples include but are not limited to switch type buck regulators, boost regulators, buck/boost regulators, switch capacitor regulators, low dropout (LDO) regulators, linear regulators and hybrid regulators (combinations of different regulator types).

A hybrid coupled inductor-based voltage regulator as described herein can use one or more pairs (N pairs) of coupled inductors along with one uncoupled inductor. The technology includes establishing a frequency for the uncoupled phase which is a multiple of the frequency for the coupled phases. For example, the coupled phases (2N phases) work as a 2N interleaved manner at a base switching frequency, and the frequency of the uncoupled phase is set at a value of approximately 2N times the base frequency. In addition, the technology provides for selecting a phase shift for the uncoupled phase relative to one of the coupled phases to reduce the output ripple current. Further, the technology can include selecting the uncoupled inductor to achieve output ripple reduction while also reducing converter power loss. By employing the techniques described herein, the technology significantly enhances performance of the voltage regulator circuit (e.g., reduction of ripple current) while reducing the number of components and, hence, circuit real estate occupied thereby.

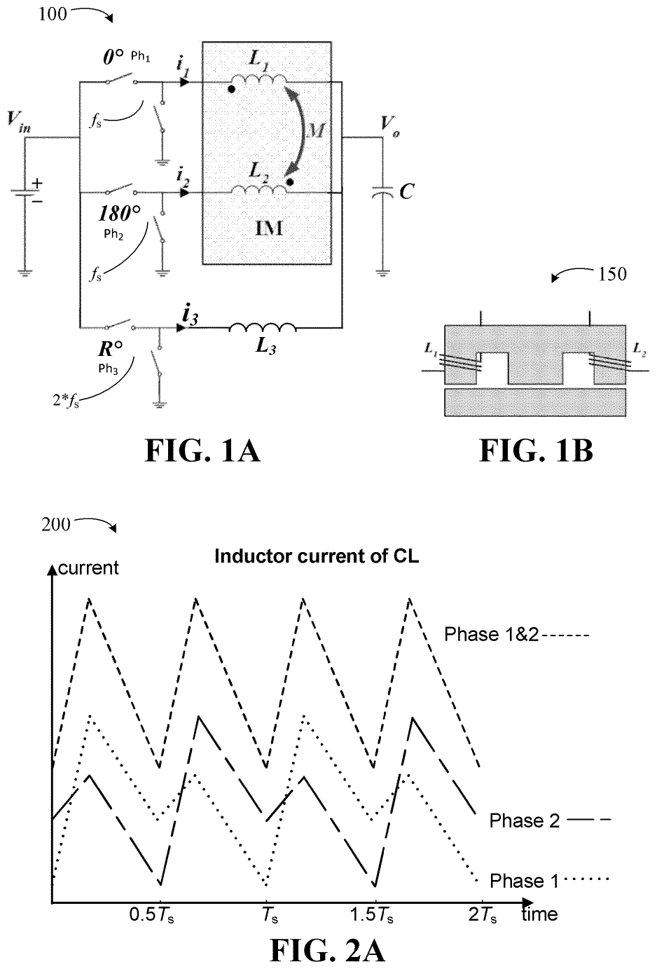

FIG. 1A provides a diagram illustrating an example of a controlled voltage regulator (VR) circuit 100 according to one or more embodiments, with reference to components and features described herein including but not limited to the figures and associated description. The VR circuit 100 is a hybrid coupled inductor-based VR circuit and operates in conjunction with a VR controller (not shown) that selectively activates/de-activates switches in the VR circuit to generate the respective current phases. The example VR circuit 100 illustrates a three-phase regulator circuit, but the technology as described herein can be extended and applied to other hybrid CL based VR circuits with an odd phase (e.g., uncoupled phase). As shown in FIG. 1A, the VR circuit 100 includes a coupled inductor pair L₁ and L₂ which are operated via switches with phasing Ph₁ and Ph₂ to generate currents i₁ and i₂ respectively. In operation the CL pair will exhibit a mutual inductance M. The switches controlling currents i₁ and i₂ are operated by timing signals such that phases Ph₁ and Ph₂ are 180 degrees apart. As an example, in some embodiments the switches controlling currents i₁ and i₂ are operated via pulse width modulation (PWM) signals such that the “on” sequences for i₁ and i₂ are 180 degrees apart. In embodiments, a controlled VR circuit will have a plurality of CL pairs. In such cases the respective currents in any particular CL pair are operated by timing signals such that the phases for the currents in the pair are 180 degrees apart.

The VR circuit 100 includes an uncoupled inductor L₃ which is operated via switches with phasing Ph₃ to generate current i₃. The switches controlling the current i₃ are operated such that the phasing Ph₃ has a phase shift of R degrees with reference to the first phase Ph₁ (or, alternatively, with reference to the second phase Ph₂). As an example, the switches controlling current i₃ can be operated via pulse width modulation signals such that the “on” sequence has a phase shift of R degrees to the phasing Ph₁ or Ph₂.

The VR circuit 100 includes an input voltage Vᵢₙ provided, e.g., from an input voltage source. The VR circuit 100 also includes a capacitor C across the output voltage Vₒ which is coupled to each of the coupled inductors L₁ and L₂ and to the uncoupled inductor L₃. In embodiments, the output voltage Vₒ will be related to the input voltage Vᵢₙ based on the collective duty cycle of the switches controlling the currents in the circuit, where the duty cycle represents, e.g., the ratio of time the current-supplying switches are on, collectively, compared with the cycle time or period. As illustrated in FIG. 1A, the VR circuit 100 has a topology known as a buck regulator (sometimes known alternatively as a buck converter, since the circuit can convert the input voltage Vᵢₙ to a different output voltage Vₒ via varying the duty cycle). It will be understood that the VR circuit 100 can be implemented using other circuit topologies, and/or can include one or more additional CL pair(s) and/or other additional components (not shown in FIG. 1A). In embodiments, the switches can be implemented using transistors, e.g., MOSFET transistors.

FIG. 1B provides a diagram illustrating an example of a coupled inductor pair 150 according to one or more embodiments, with reference to components and features described herein including but not limited to the figures and associated description. The example coupled inductor pair 150 can be used in the VR circuit 100 (FIG. 1A, already discussed). The coupled inductor pair 150 consists of two inductors L₁ and L₂ which are wound, respectively, on a common magnetic core (top structure). As illustrated in FIG. 1B, the magnetic core includes a bottom magnetic structure forming narrow air gaps with the legs in the top structure. It will be understood that other core structures (e.g., with different configurations of magnetic components and/or arrangement of inductor windings) can be used to form a coupled inductor pair suitable for use in the VR circuit 100.

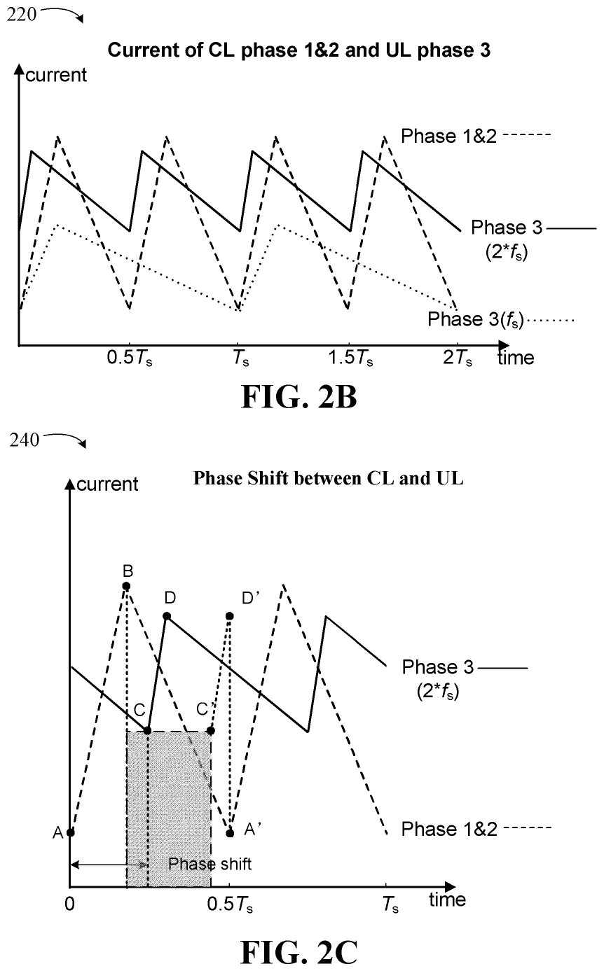

FIGS. 2A-2D provide diagrams illustrating examples of currents in the VR circuit 100 according to one or more embodiments, with reference to components and features described herein including but not limited to the figures and associated description. The diagrams each illustrate currents with reference to the switching period, Tₛ which is equal to 1/fₛ, where the switching frequency fₛ corresponds to the timing signals operating the respective switches for a single coupled phase in the VR circuit 100. Turning to FIG. 2A, a diagram 200 illustrates current in the coupled inductor (CL) pair. The Phase 1 current (triggered by the signal with timing phase Ph₁) represents the current i₁ flowing through L₁, and the Phase 2 current (triggered by the signal with timing phase Ph₂) represents the current i₂ flowing through L₂. The combined currents are illustrated as Phase 1&2 in the diagram 200. The currents are generated based on a phase difference between Ph₁ and Ph₂ of 180 degrees. The current waveform of each phase has two rising stages in a period because of the mutual inductance (M) of the CL pair, while the overall output current of phase 1&2 maintains consistency in every half of a period. As shown in the diagram, the combined current phase 1&2 exhibits an equivalent frequency equal to double the base switching frequency fₛ of a single coupled phase.

Turning now to FIG. 2B, a diagram 220 illustrates potential currents for Phase 3 (uncoupled phase) superimposed on the combined CL current for Phase 1&2. The Phase 3 current represents the current i₃ flowing through the uncoupled inductor L₃. Two example currents for Phase 3 are shown in FIG. 2B, one corresponding to a switching frequency for the uncoupled phase equal to the base switching frequency fₛ, and the other one corresponding to a switching frequency for the uncoupled phase equal to twice (2×) the base switching frequency fₛ. When combined with the CL current in the VR circuit 100, the Phase 3 current (uncoupled inductor current i₃) can cause undesired artifacts—e.g., an unbalance and/or large total output ripple current of the regulator if the switching frequency for the uncoupled phase is the same as the base switching frequency fₛ. On the other hand, if the switching frequency for the uncoupled phase is set to twice the base switching frequency fₛ (i.e., 2*fₛ) to match the equivalent frequency of the overall CL output, then the undesired artifacts can be reduced, minimized or avoided.

Turning now to FIG. 2C, a diagram 240 illustrates timing aspects for Phase 3 (uncoupled phase) current with frequency 2*fₛ superimposed on the combined CL current for Phase 1&2. Because of the periodic linearity of the waveforms, the peak and valley points of the overall output current (combined Phase 1&2 with Phase 3) must be at one the points A, B, C or D, as shown in the diagram 240. Given that the values of A and B are fixed with selected CL phase parameters, the impact of a phase shift between the uncoupled phase (Phase 3) and the first CL phase (Phase 1) can be evaluated. As illustrated in FIG. 2C, the point sequence from left to right is A-B-C-D, where the maximum point is either B or D, and the minimum value is A or C, based on the monotonicity of slew rate. The phase shift can vary in the shadowed zone shown in FIG. 2C. The overall output ripple current of the VR circuit is minimized when the uncoupled phase shift R (in degrees) is selected in the range given by EQ. (1):

$$EQ . ( 1 )$$

$$R = range between : \frac{360 {L}_{k}}{{L}_{k} + 2 {L}_{d i s}} + 360 D and 360 - \frac{36 {0}_{k}}{{L}_{k} + 2 {L}_{d i s}}$$

where Lₖ is the value of the leakage inductance of the coupled inductor pair (e.g., the coupled inductor pair L₁ and L₂ in the VR circuit 100, FIG. 1A); L_{dis} is the value of the discrete (uncoupled) inductor (e.g., L₃ in the VR circuit 100, FIG. 1A); and D is the duty cycle (D=Vₒ/Vᵢₙ). The mutual inductance Lₘ of the CL pair can be effectively ignored because the slew rate for the overall CL phases ripple current is dominated by the leakage inductance Lₖ instead of the mutual inductance Lₘ.

Turning now to FIG. 2D, a diagram 260 illustrates an example of the overall current for combined Phases 1, 2 and 3, when the phase shift R is in the range provided by EQ. (1). The effect of total ripple waveform is illustrated in FIG. 2D, and the total minimum ripple will be determined by amplitude of AB. In one example, a value L_{dismin} can be determined by equating the two endpoints of the range in EQ. (1). Let

$$\frac{36 {0}_{k}}{{L}_{k} + 2 {L}_{d i s}} + 360 D = 360 - \frac{360 {L}_{k}}{{L}_{k} + 2 {L}_{d i s}} \qquad EQ . ( 2 )$$

Solving EQ. 2 for L_{dis} gives

$${L}_{d i s} = {L}_{dismin} = \frac{1 + D}{2 ( 1 - D )} {L}_{k} \qquad EQ . ( 3 )$$

Substituting this value of L_{dis} into EQ. (1) yields a phase shift R:

R=180*(1+D) EQ. (4)

The phase shift R (in degrees) provided in EQ. 4 can be implemented without dependency on Lₖ/L_{dis}, so long as L_{dis} is greater than or equal to L_{dismin} (as provided by EQ. (3)). In practical terms, choosing the value L_{dis}>L_{dismin} will ensure the current slew rate of the uncoupled phase is low enough to ensure point C is above point A, and point D is below point B. The value of L_{dismin}, e.g., as provided by EQ. (3), can thus be considered a threshold inductance.

The choice of the discrete (uncoupled) inductor L_{dis} also impacts the uncoupled phase ripple current and thus the power loss for the uncoupled phase. RMS current related loss is a key contributor to overall converter loss. In practice, the CL parameters are typically optimized at a ratio of Lₛ/Lₖ (self-inductance/leakage inductance) ranging from 2.5 to 3.3. This ratio can be utilized for selecting the discrete inductance L_{dis} for uncoupled phase such that:

L_{dis}=(3±20%)*L_{dismin} EQ. (5)

At this value, the VR circuit can achieve both lower total output ripple current and lower RMS loss for the uncoupled phase, while the RMS current of the uncoupled phase is almost same as the coupled phase to achieve a balanced RMS loss overall for the VR circuit.

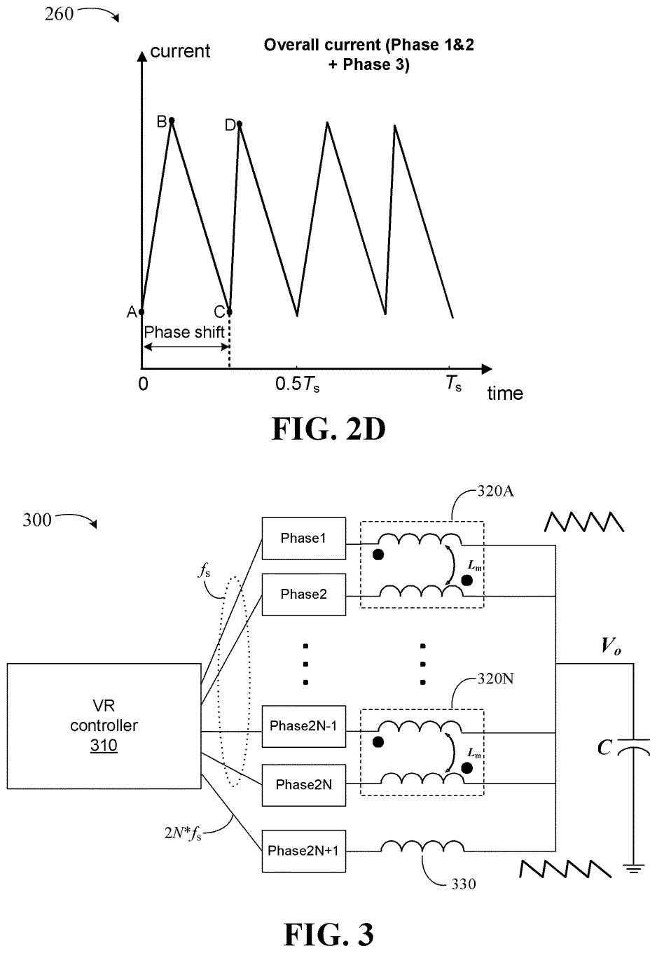

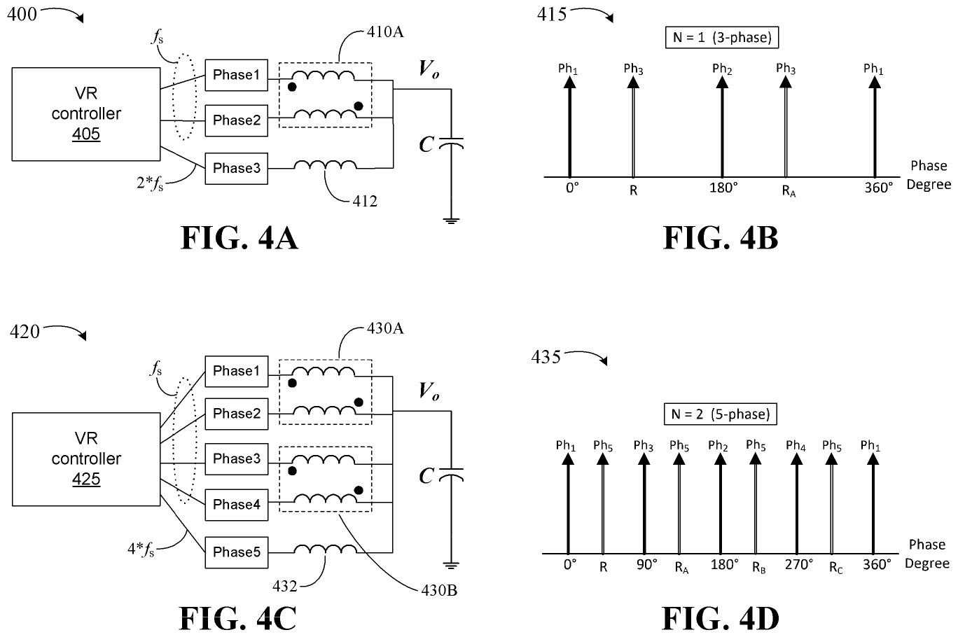

The foregoing inferences can be extended and applied to more general cases where the voltage regulator circuit (e.g., the VR circuit 100) includes a plurality (N) of coupled inductor pairs along with an uncoupled inductor. The CL pairs have currents for phases 1 through 2N, each phase interleaved and controlled by a signal having a switching frequency at the base frequency fₛ, and the uncoupled inductor has current for phase 2N+1. In such cases, the combined currents for the coupled inductor phases will exhibit an equivalent frequency equal to double the base switching frequency fₛ times N (i.e., 2N*fₛ). Thus, to reduce, minimize or avoid the undesired artifacts, the uncoupled inductor phase can be controlled with a signal having a switching frequency equal to twice the base switching frequency times N (i.e., 2N*fₛ). Further details regarding hybrid CL-based circuits (including hybrid multi-CL pair circuits) are provided herein with reference to FIGS. 3 and 4A-4F.

FIG. 3 provides a diagram illustrating a topology for an example controlled voltage regulator (VR) 300 according to one or more embodiments, with reference to components and features described herein including but not limited to the figures and associated description. The VR 300 provides a generalized example odd phase controlled VR circuit for 2N+1 phases, where N is the number of coupled inductor pairs. The VR 300 includes a VR controller 310, and a VR circuit including one or more coupled inductor pairs 320 (illustrated as 320a-320N in FIG. 3) and an uncoupled inductor 330 (providing the odd phase). In embodiments, the VR 300 includes a capacitor C (e.g., an output capacitor) across the output voltage Vₒ which is coupled to an output side of each of the coupled inductor pairs 320 and to an output side of the uncoupled inductor 330. An input voltage Vᵢₙ (not shown in FIG. 3) is coupled through switches (illustrated in FIG. 3 as Phase1, Phase2, . . . Phase2N−1 and Phase 2N) to an input side of each of the coupled inductor pairs 320 and through a switch (illustrated in FIG. 3 as Phase 2N+1) to an input side of the uncoupled inductor 330, where N is the number of coupled inductor pairs. In some embodiments, the VR circuit in the VR 300 corresponds to, or is based on the same or similar components in, the VR circuit 100 (FIG. 1A, already discussed).

The VR controller 310 sequentially activates switches for the coupled inductor pairs 320 (e.g., via PWM signals) at the base switching frequency fₛ. In some embodiments the VR controller includes a pulse generator (e.g., a pulse width modulation generator). In some embodiments, the base switching frequency can be in the range of approximately 150 kHz-6.5 MHz. As one example, the base switching frequency can be approximately 800 kHz. The VR controller 310 further activates switch(es) for the uncoupled inductor 330 (e.g., via PWM signals) at a frequency 2N*fₛ, where N is the number of coupled inductor pairs. In embodiments the switches for Phase1, Phase2, . . . Phase2N+1 are arranged similar to the arrangement of switches in the VR circuit 100 (FIG. 1A, already discussed). As all CL phases are operated in a symmetrical 2N mode, the VR 300 represents an odd phase 2N+1 circuit with an equivalent CL circuit frequency of 2N*fₛ (as a fixed CL output) and one uncoupled output (with phase2N+1). In embodiments, the number of phases and/or the number of coupled inductor pairs is selected based on output power or current requirements. The higher the value of N, the greater the amount of power or current that can be delivered by the VR 300.

The VR 300 (including the VR controller 310, the VR circuit, or portions thereof) can be implemented via logic and/or circuit components in a semiconductor apparatus, a circuit board, etc. For example, the VR 300 can be implemented in a central processing unit (CPU) and/or as part of a system on chip (SoC). Selection of components and component values for the VR circuit in the VR 300 can vary based on specific design criteria, such as base switching frequency fₛ, voltage input, power requirements, etc. In embodiments, the switches can be implemented using transistors, e.g., MOSFET transistors.

More particularly, the VR controller 310 can be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality logic hardware using circuit technology such as, for example, application specific integrated circuit (ASIC), general purpose microprocessor or transistor-transistor logic (TTL) technology, or any combination thereof. Moreover, the configurable and/or fixed-functionality hardware can be implemented via complementary metal oxide semiconductor (CMOS) technology.

For example, computer program code to carry out operations of the VR controller 310 can be written in any combination of one or more programming languages, including an object oriented programming language such as JAVA, SMALLTALK, C++ or the like and conventional procedural programming languages, such as the “C” programming language or similar programming languages.

Additionally, logic instructions can include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

FIGS. 4A-4F provide diagrams illustrating examples of topologies for a controlled voltage regulator (VR) along with associated signal timing diagrams according to one or more embodiments, with reference to components and features described herein including but not limited to the figures and associated description. The VR topologies illustrated and explained with reference to FIGS. 4A-4F are based on the VR topology illustrated in FIG. 3. In particular, the VR topologies illustrated in FIGS. 4A, 4C and 4E include components and features the same as or similar to those illustrated and described with reference to the VR 300 (FIG. 3, already discussed), and description of those components and features will not be repeated except as necessary to describe the components, features or operation of the VR topologies illustrated and described with reference to FIGS. 4A-4F.

Turning to FIG. 4A, an example three-phase VR 400 is illustrated for the case N=1 (single CL pair). The VR 400 includes a VR controller 405, and a VR circuit including a coupled inductor pair 410A and an uncoupled inductor 412 (providing the odd phase). The VR controller 405 sequentially activates switches for the coupled inductor pair 410A (e.g., via PWM signals) at the base switching frequency fₛ. The VR controller 405 further activates switch(es) for the uncoupled inductor 412 (e.g., via PWM signals) at a frequency 2*fₛ (for N=1).

Turning now to FIG. 4B, a timing diagram is illustrated showing an example “firing” sequence 415 for activating the three phases of the VR 400. Each “spike” in the diagram represents the timing for triggering (e.g., via the leading edge of a rising PWM signal) the respective current phase. Each of the phase 1 and phase 2 currents are triggered once per 360 degree period (base switching frequency). Thus, as illustrated in FIG. 4B, the phase 1 current is triggered at 0 degrees, and the phase 2 current is triggered at 180 degrees; as explained above with reference to FIG. 1A, the currents for any respective CL pair are phased 180 degrees apart. The uncoupled inductor phase 3 current is triggered twice during the period (the uncoupled phase trigger rate is 2*fₛ; each uncoupled phase will be 360/2=180 degrees apart). The phase 3 current (e.g., for the first triggered phase 3 current, shown as R in FIG. 4B) is set at a phase shift R degrees from the phase 1 current (e.g., Ph₁+R). The phase shift R can be set as described herein with reference to FIGS. 2A-2D. The second triggered phase 3 current (shown as R_{A} in FIG. 4B) is based on the phase 2 current, e.g., R_{A}=Ph₂+R (also, R_{A}=R+180 in FIG. 4B).

Turning now to FIG. 4C, an example five-phase VR 420 is illustrated for the case N=2 (two CL pairs). The VR 420 includes a VR controller 425, and a VR circuit including two coupled inductor pairs (430A and 430B) and an uncoupled inductor 432 (providing the odd phase). The VR controller 425 sequentially activates switches for the coupled inductor pairs 430A-430B (e.g., via PWM signals) at the base switching frequency fₛ. The VR controller 425 further activates switch(es) for the uncoupled inductor 432 (e.g., via PWM signals) at a frequency 4*fₛ (for N=2).

Turning now to FIG. 4D, a timing diagram is illustrated showing an example “firing” sequence 435 for activating the five phases of the VR 420. Each “spike” in the diagram represents the timing for triggering (e.g., via the leading edge of a rising PWM signal) the respective current phase. Each of the CL currents (e.g., phase 1, phase 2, phase 3 and phase 4) are triggered once per 360 degree period (base switching frequency). With four CL phases, a CL phase is triggered at each 360/4=90 degrees. Thus, as illustrated in FIG. 4D, for the CL pair 430A the phase 1 current is triggered at 0 degrees, and the phase 2 current is triggered at 180 degrees (as explained above with reference to FIG. 1A, the currents for any respective CL pair are phased 180 degrees apart). For the CL pair 430B, the phase 3 current is triggered at 90 degrees, and the phase 4 current is triggered at 270 degrees. The uncoupled inductor phase 5 current is triggered four times during the period (the uncoupled phase trigger rate is 4*fₛ; each uncoupled phase will be 360/4=90 degrees apart). The phase 5 current (e.g., for the first triggered phase 5 current, shown as R in FIG. 4D) is set at a phase shift R degrees from the phase 1 current. The phase shift R can be set as described herein with reference to FIGS. 2A-2D.

The second triggered phase 5 current (shown as R_{A} in FIG. 4D) is based on the phase 3 current, e.g., R_{A}=Ph₃+R (also, R_{A}=R+90 in FIG. 4D). Similarly, the third and fourth triggered phase 5 currents (shown as R_{B} and R_{C} in FIG. 4D) are based on the phase 2 and phase 4 currents, respectively, e.g., R_{B}=Ph₂+R and R_{C}=Ph₄+R (also, R_{B}=R+180 and R_{C}=R+270 in FIG. 4D).

Turning now to FIG. 4E, an example seven-phase VR 440 is illustrated for the case N=3 (three CL pairs). The VR 440 includes a VR controller 445, and a VR circuit including three coupled inductor pairs (450A, 450B and 450C) and an uncoupled inductor 452 (providing the odd phase). The VR controller 445 sequentially activates switches for the coupled inductor pairs 450A-450C (e.g., via PWM signals) at the base switching frequency fₛ. The VR controller 445 further activates switch(es) for the uncoupled inductor 452 (e.g., via PWM signals) at a frequency 6*fₛ (for N=3).

Turning now to FIG. 4F, a timing diagram is illustrated showing an example “firing” sequence 455 for activating the seven phases of the VR 440. Each “spike” in the diagram represents the timing for triggering (e.g., via the leading edge of a rising PWM signal) the respective current phase. Each of the CL currents (e.g., phase 1, phase 2, phase 3, phase 4, phase 5 and phase 6) are triggered once per 360 degree period (base switching frequency). With six CL phases, a CL phase is triggered at each 360/6=60 degrees. Thus, as illustrated in FIG. 4F, for the CL pair 450A the phase 1 current is triggered at 0 degrees, and the phase 2 current is triggered at 180 degrees (as explained above with reference to FIG. 1A, the currents for any respective CL pair are phased 180 degrees apart). For the CL pair 450B, the phase 3 current is triggered at 60 degrees, and the phase 4 current is triggered at 240 degrees. For the CL pair 450C, the phase 5 current is triggered at 120 degrees, and the phase 6 current is triggered at 300 degrees. The uncoupled inductor phase 7 current is triggered six times during the period (the uncoupled phase trigger rate is 6*fₛ; each uncoupled phase will be 360/6=60 degrees apart). The phase 7 current (e.g., for the first triggered phase 7 current, shown as R in FIG. 4F) is set at a phase shift R degrees from the phase 1 current. The phase shift R can be set as described herein with reference to FIGS. 2A-2D.

The second triggered phase 7 current (shown as R_{A} in FIG. 4F) is based on the phase 3 current, e.g., R_{A}=Ph₃+R (also, R_{A}=R+60 in FIG. 4F). Similarly, the third through sixth triggered phase 7 currents (shown as R_{B}, R_{C}, R_{D} and R_{E} in FIG. 4F) are based on the phase 5, phase 2, phase 4 and phase 6 currents, respectively, e.g., R_{B}=Ph₅+R, R_{C}=Ph₂+R, R_{D}=Ph₄+R, and R_{E}=Ph₆+R (also R_{B}=R+120, R_{C}=R+180, R_{D}=R+240, and R_{E}=R+300 in FIG. 4D).

In embodiments, the VR 400, the VR 420, and/or the VR 440 correspond to the VR 300 (FIG. 3, already discussed), and can be implemented in like manner to implementation of the VR 300. In embodiments, the VR controller 405, the VR controller 425, and/or the VR controller 445 correspond to the VR controller 310 (FIG. 3, already discussed), and can be implemented in like manner to implementation of the VR controller 310.

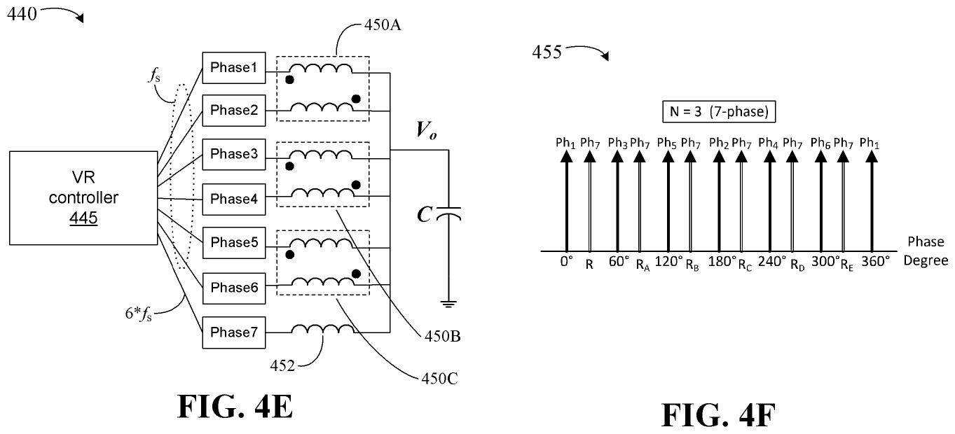

FIG. 5 provides a flow diagram illustrating an example method 500 for controlling a voltage regulator according to one or more embodiments, with reference to components and features described herein including but not limited to the figures and associated description. The method 500 can be implemented in a VR such as, e.g., the VR 300 (FIG. 3, already discussed), the VR 400 (FIG. 4A, already discussed), the VR 420 (FIG. 4C, already discussed), and/or the VR 440 (FIG. 4E, already discussed). The method 500 can be performed by or under direction of a voltage regulator controller such as, e.g., the VR controller 310 (FIG. 3, already discussed), the VR controller 405 (FIG. 4A, already discussed), the VR controller 425 (FIG. 4C, already discussed), and/or the VR controller 445 (FIG. 4E, already discussed).

More particularly, the method 500 can be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality logic hardware using circuit technology such as, for example, ASIC, general purpose microprocessor or TTL technology, or any combination thereof. Moreover, the configurable and/or fixed-functionality hardware can be implemented via CMOS technology.

For example, computer program code to carry out operations shown in the method 500 can be written in any combination of one or more programming languages, including an object oriented programming language such as JAVA, SMALLTALK, C++ or the like and conventional procedural programming languages, such as the “C” programming language or similar programming languages. Additionally, logic instructions can include assembler instructions, ISA instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Turning to FIG. 5, illustrated processing block 510a provides for generating a first set of control signals to control current in one or more coupled inductor pairs in a voltage regulator (VR) circuit, where at block 510b the control signals for each coupled inductor pair operate at a first frequency representing a base operation frequency of each coupled inductor phase. Illustrated processing block 520a provides for generating a second control signal at a second frequency to control current in an uncoupled inductor in the VR circuit, where at block 520b the second frequency is set relative to the first frequency to control ripple in an output current of the VR circuit. For the VR circuit, an output of the uncoupled inductor is electrically coupled to an output of each of the one or more coupled inductor pairs, and the first set of control signals and the second control signal represent, in combination, an odd phase count.

In some embodiments, at illustrated processing block 530 the second frequency is set based on the first frequency and on a number of coupled inductor pairs in the VR circuit. In some embodiments, the second frequency is set to a value the same as or approximately equal to 2N times the first frequency (e.g., 2N*fₛ), where N is the number of coupled inductor pairs in the VR circuit. In some embodiments, a value approximately equal to 2N times the first frequency is within the range 2N*fₛ plus or minus ten percent (10%).

In some embodiments, illustrated processing block 540 provides for setting a phase shift of the second control signal relative to a first phase of one of the first set of control signals to further control the ripple in the output current of the VR circuit. In some embodiments, at illustrated processing block 550 the phase shift of the second control signal is set based on one or more of a duty cycle of the VR circuit, an inductance of the uncoupled inductor, or a leakage inductance of one of the coupled inductor pairs. In some embodiments, the phase shift of the second control signal is set to a value approximately equal to 180 degrees times (1+D), wherein D is the duty cycle of the VR circuit. In some embodiments, a value approximately equal to 180 degrees times (1+D) is in the range 180 degrees times (1+D) plus or minus ten percent (10%).

In some embodiments, at illustrated processing block 560 the inductance of the uncoupled inductor exceeds a threshold inductance based on the duty cycle of the VR circuit and the leakage inductance of one of the coupled inductor pairs. In some embodiments, the inductance of the uncoupled inductor is a value approximately three times the threshold inductance—for example, in such cases the inductance of the uncoupled inductor can be a value in the range three times the threshold inductance plus or minus 20 percent (20%).

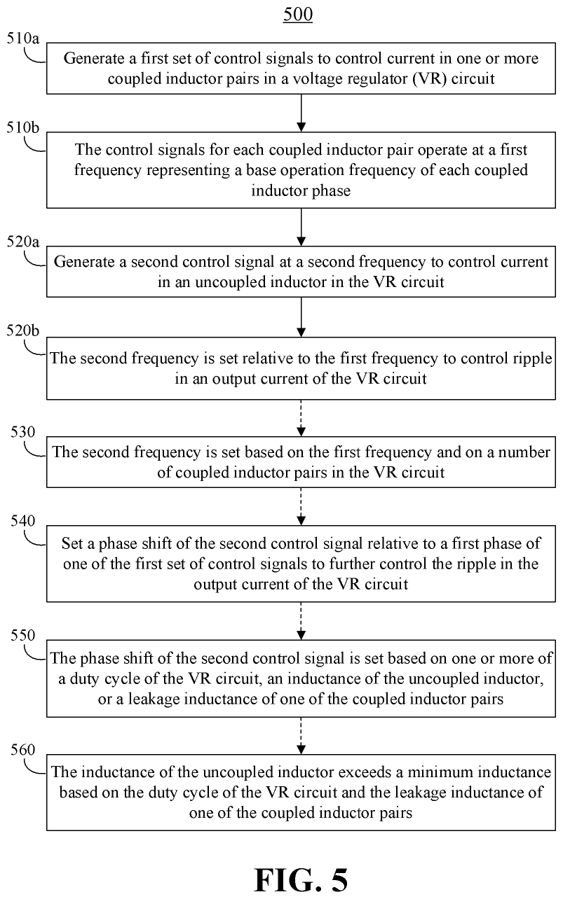

FIG. 6 shows a block diagram illustrating an example performance-enhanced computing system 10 having a controlled voltage regulator according to one or more embodiments, with reference to components and features described herein including but not limited to the figures and associated description. The system 10 can generally be part of an electronic device/platform having computing and/or communications functionality (e.g., a server, cloud infrastructure controller, database controller, notebook computer, desktop computer, personal digital assistant/PDA, tablet computer, convertible tablet, smart phone, etc.), imaging functionality (e.g., camera, camcorder), media playing functionality (e.g., smart television/TV), wearable functionality (e.g., watch, eyewear, headwear, footwear, jewelry, or other wearable devices), vehicular functionality (e.g., car, truck, motorcycle), robotic functionality (e.g., robot or autonomous robot), Internet of Things (IoT) functionality, etc., or any combination thereof. In the illustrated example, the system 10 can include a host processor 12 (e.g., central processing unit/CPU) having an integrated memory controller (IMC) 14 that can be coupled to system memory 20. The host processor 12 can include any type of processing device, such as, e.g., microcontroller, microprocessor, RISC processor, ASIC, etc., along with associated processing modules or circuitry. The system memory 20 can include any non-transitory machine- or computer-readable storage medium such as RAM, ROM, PROM, EEPROM, firmware, flash memory, etc., configurable logic such as, for example, PLAs, FPGAs, CPLDs, fixed-functionality hardware logic using circuit technology such as, for example, ASIC, CMOS or TTL technology, or any combination thereof suitable for storing instructions 28.

The system 10 can also include an input/output (I/O) module 16. The I/O module 16 can communicate with for example, one or more input/output (I/O) devices 17, a network controller 24 (e.g., wired and/or wireless NIC), and storage 22. The storage 22 can be comprised of any appropriate non-transitory machine- or computer-readable memory type (e.g., flash memory, DRAM, SRAM (static random access memory), solid state drive (SSD), hard disk drive (HDD), optical disk, etc.). The storage 22 can include mass storage. In some embodiments, the host processor 12 and/or the I/O module 16 can communicate with the storage 22 (all or portions thereof) via a network controller 24. In some embodiments, the system 10 can also include a graphics processor 26 (e.g., a graphics processing unit/GPU) and/or an AI accelerator (not shown in FIG. 6).

The host processor 12 and the I/O module 16 can be implemented together on a semiconductor die as a system on chip (SoC) 11, shown encased in a solid line. The SoC 11 can therefore operate as a computing apparatus having a controlled voltage regulator. In some embodiments, the SoC 11 can also include one or more of the system memory 20, the network controller 24, and/or the graphics processor 26 (shown encased in dotted lines). In some embodiments, the SoC 11 can also include other components of the system 10.

The system 10 includes a voltage regulator 19, which can include or correspond to the VR 300, the VR controller 310, the VR 400, the VR controller 405, the VR 420, the VR controller 425, the VR 440, and/or the VR controller 445.

In embodiments, the voltage regulator 19 is coupled to the SoC 11 or the host processor 12. For example, in some embodiments the voltage regulator 19 is included within the SoC 11 or the host processor 12. As another example, in some embodiments the voltage regulator 19 lies outside of the SoC 11 or the host processor 12. In some embodiments, the system 10 (e.g., the SoC 11 or the host processor 12) includes logic (e.g., configurable hardware, fixed-functionality hardware, etc., or any combination thereof) to implement one or more aspects of the method 500 (FIG. 5, already discussed). The host processor 12 and/or the I/O module 16 can execute program instructions 28 retrieved from the system memory 20 and/or the storage 22 to perform one or more processes suitable for computing systems generally. The system 10 is therefore considered to be performance-enhanced at least to the extent that the technology provides a voltage regulator controller for controlling a VR circuit having currents providing an odd phase count while controlling output ripple current.

Computer program code to carry out the processes described above can be written in any combination of one or more programming languages, including an object-oriented programming language such as JAVA, JAVASCRIPT, PYTHON, SMALLTALK, C++ or the like and/or conventional procedural programming languages, such as the “C” programming language or similar programming languages, and implemented as program instructions 28. Additionally, program instructions 28 can include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, microprocessor, etc.).

I/O devices 17 can include one or more of input devices, such as a touchscreen, keyboard, mouse, cursor-control device, microphone, digital camera, video recorder, camcorder, biometric scanners and/or sensors; input devices can be used to enter information and interact with system 10 and/or with other devices. The I/O devices 17 can also include one or more of output devices, such as a display (e.g., touchscreen, liquid crystal display/LCD, light emitting diode/LED display, plasma panels, etc.), speakers and/or other visual or audio output devices. The input and/or output devices can be used, e.g., to provide a user interface.

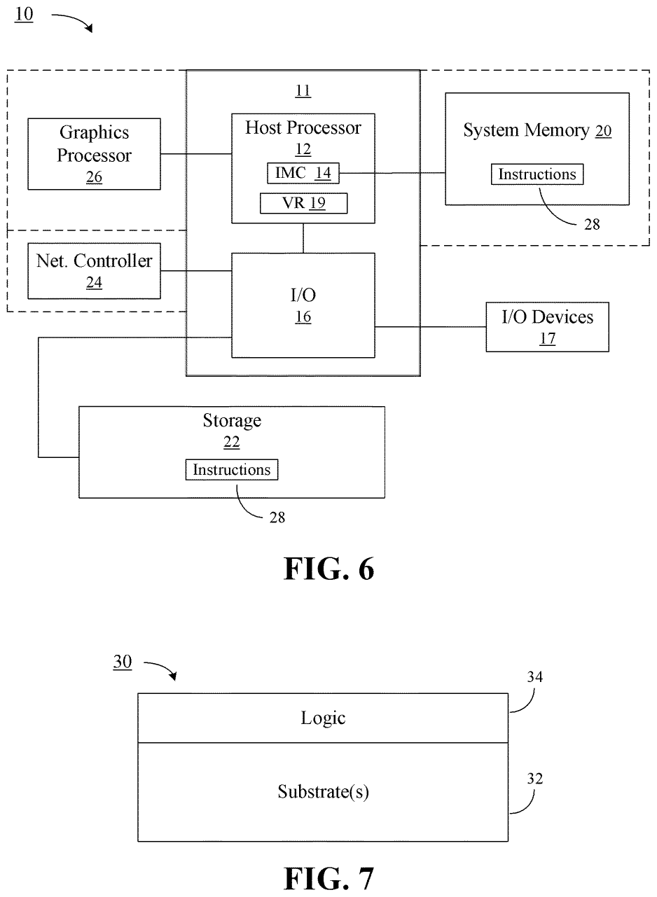

FIG. 7 shows a block diagram illustrating an example semiconductor apparatus 30 for a voltage regulator, a voltage regulator controller, and/or a computing system having a controlled voltage regulator according to one or more embodiments, with reference to components and features described herein including but not limited to the figures and associated description. The semiconductor apparatus 30 can be implemented, e.g., as a chip, die, or other semiconductor package. The semiconductor apparatus 30 can include one or more substrates 32 comprised of, e.g., silicon, sapphire, gallium arsenide, etc. The semiconductor apparatus 30 can also include logic 34 comprised of, e.g., transistor array(s) and other integrated circuit (IC) components) coupled to the substrate(s) 32. The logic 34 can be implemented at least partly in configurable logic or fixed-functionality logic hardware. The logic 34 can implement the system on chip (SoC) 11 described above with reference to FIG. 6. The logic 34 can implement one or more aspects of the processes described above, including the method 500. The logic 34 can implement one or more aspects of the VR 300, the VR controller 310, the VR 400, the VR controller 405, the VR 420, the VR controller 425, the VR 440, and/or the VR controller 445 as described herein with reference to FIGS. 1A, 3, 4A-4F and 5. The apparatus 30 is therefore considered to be performance-enhanced at least to the extent that the technology provides a voltage regulator controller for controlling a VR circuit having currents providing an odd phase count while controlling output ripple current.

The semiconductor apparatus 30 can be constructed using any appropriate semiconductor manufacturing processes or techniques. For example, the logic 34 can include transistor channel regions that are positioned (e.g., embedded) within the substrate(s) 32. Thus, the interface between the logic 34 and the substrate(s) 32 may not be an abrupt junction. The logic 34 can also be considered to include an epitaxial layer that is grown on an initial wafer of the substrate(s) 34.

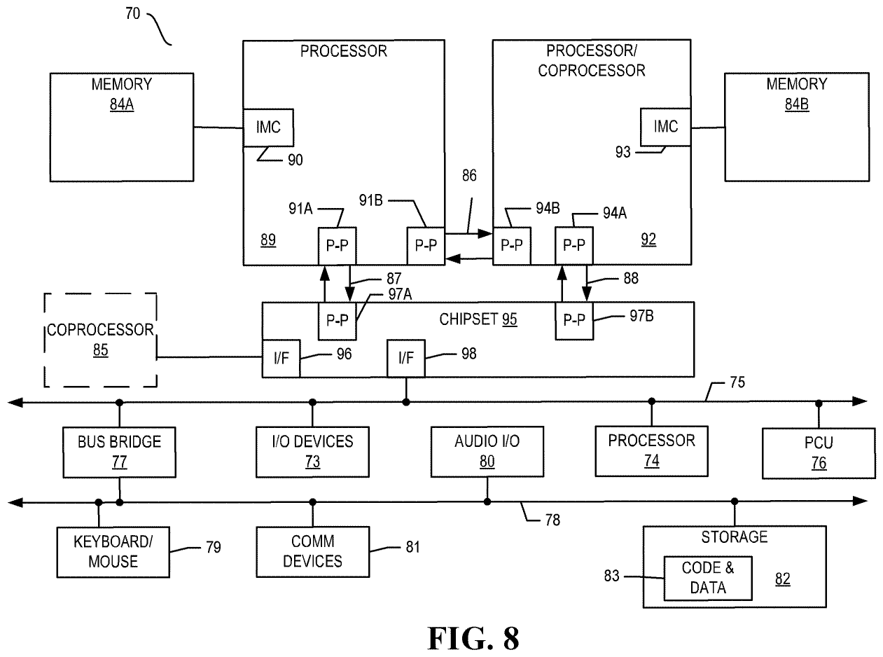

FIG. 8 illustrates an example computing system according to one or more embodiments, with reference to components and features described herein including but not limited to the figures and associated description. Multiprocessor system 70 is an interfaced system and includes a plurality of processors including a first processor 89 and a second processor 92 coupled via an interface 86 such as a point-to-point (P-P) interconnect, a fabric, and/or bus. In some examples, the first processor 89 and the second processor 92 are homogeneous. In some examples, first processor 89 and the second processor 92 are heterogenous. Though the example system 70 is shown to have two processors, the system can have three or more processors, or can be a single processor system. In some examples, the computing system is implemented, wholly or partially, with a system on a chip (SoC) or a multi-chip (or multi-chiplet) module, in the same or in different package combinations.

Processors 89 and 92 are shown including integrated memory controller (IMC) circuitry 90 and 93, respectively. Processor 89 also includes interface circuits 91A and 91B, along with core sets. Similarly, second processor 92 includes interface circuits 94A and 94B, along with a core set as well. A core set generally refers to one or more compute cores that may or may not be grouped into different clusters, hierarchal groups, or groups of common core types. Cores can be configured differently for performing different functions and/or instructions at different performance and/or power levels. The processors can also include other blocks such as memory and other processing unit engines.

Processors 89, 92 can exchange information via the interface 86 using interface circuits 91B, 94B. IMCs 90 and 93 couple the processors 89, 92 to respective memories, namely a memory 84A and a memory 84B, which can be portions of main memory locally attached to the respective processors.

Processors 89, 92 can each exchange information with a network interface (NW I/F) 95 via individual interfaces 87, 88 using interface circuits 91A, 97A, 94A, 97B. The network interface 95 (e.g., one or more of an interconnect, bus, and/or fabric, and in some examples is a chipset) can optionally exchange information with a coprocessor 85 via an interface circuit 96. In some examples, the coprocessor 85 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) can be included in either processor 89, 92 or outside of both processors, yet connected with the processors via an interface such as P-P interconnect, such that either or both processors' local cache information can be stored in the shared cache if a processor is placed into a low power mode.

Network interface 95 can be coupled to a first interface 75 via interface circuit 98. In some examples, first interface 75 can be an interface such as a Peripheral Component Interconnect (PCI) interconnect, a PCI Express interconnect, or another I/O interconnect. In some examples, first interface 75 is coupled to a power control unit (PCU) 76, which can include circuitry, software, and/or firmware to perform power management operations with regard to the processors 89, 92 and/or co-processor 85. PCU 76 provides control information to one or more voltage regulators (not shown) to cause the voltage regulator(s) to generate the appropriate regulated voltage(s). PCU 76 also provides control information to control the operating voltage generated. In various examples, PCU 76 can include a variety of power management logic units (circuitry) to perform hardware-based power management. Such power management can be wholly processor controlled (e.g., by various processor hardware, and which can be triggered by workload and/or power, thermal or other processor constraints) and/or the power management can be performed responsive to external sources (such as a platform or power management source or system software).

PCU 76 is illustrated as being present as logic separate from the processor 89 and/or processor 92. In other cases, PCU 76 can execute on a given one or more of cores (not shown) of processor 89 or 92. In some cases, PCU 76 can be implemented as a microcontroller (dedicated or general-purpose) or other control logic configured to execute its own dedicated power management code, sometimes referred to as P-code. In yet other examples, power management operations to be performed by PCU 76 can be implemented externally to a processor, such as by way of a separate power management integrated circuit (PMIC) or another component external to the processor. In yet other examples, power management operations to be performed by PCU 76 can be implemented within BIOS or other system software. Along these lines, power management can be performed in concert with other power control units implemented autonomously or semi-autonomously, e.g., as controllers or executing software in cores, clusters, IP blocks and/or in other parts of the overall system.

Various I/O devices 73 can be coupled to first interface 75, along with a bus bridge 77 which couples first interface 75 to a second interface 78. In some examples, one or more additional processor(s) 74, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 75. In some examples, second interface 78 can be a low pin count (LPC) interface. Various devices can be coupled to second interface 78 including, for example, a keyboard and/or mouse 79, communication devices 81 and storage circuitry 82. Storage circuitry 82 can be one or more non-transitory machine-readable storage media as described below, such as a disk drive or other mass storage device which can include instructions/code and data 83. Further, an audio I/O 80 can be coupled to second interface 78. Note that other architectures than the point-to-point architecture described above are possible. For example, instead of the point-to-point architecture, a system such as multiprocessor system 70 can implement a multi-drop interface or other such architecture.

Processor cores can be implemented in different ways, for different purposes, and in different processors. For instance, implementations of such cores can include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors can include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which can include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that can be included on the same die as the described CPU (sometimes referred to as the application core(s) or application processor(s)), the above described coprocessor, and additional functionality.

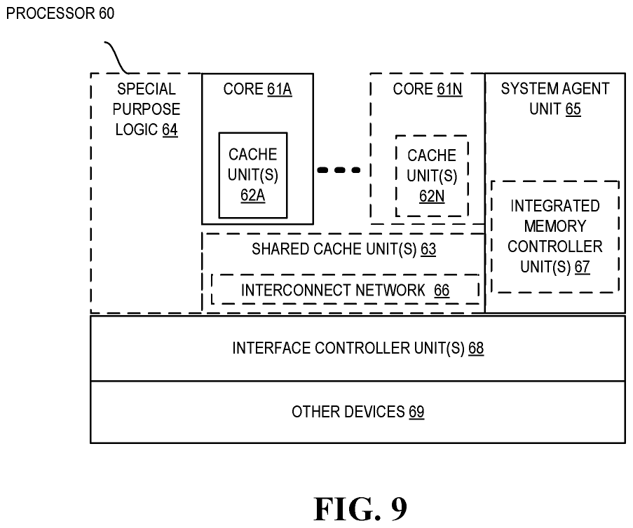

FIG. 9 illustrates a block diagram of an example processor and/or SoC 60 that can have one or more cores and an integrated memory controller according to one or more embodiments, with reference to components and features described herein including but not limited to the figures and associated description. The solid lined boxes illustrate a processor 60 with a single core 61(A), system agent unit circuitry 65, and a set of one or more interface controller unit(s) circuitry 68, while the optional addition of the dashed lined boxes illustrates an alternative processor 60 with multiple cores 61(A)-(N), a set of one or more integrated memory controller unit(s) circuitry 67 in the system agent unit circuitry 65, and special purpose logic 64, as well as a set of one or more interface controller units circuitry 68. Note that the processor 60 can be one of the processors 89 or 92, or co-processor 85 or 74 of FIG. 8.

Thus, different implementations of the processor 60 can include: 1) a CPU with the special purpose logic 64 being integrated graphics and/or scientific (throughput) logic (which can include one or more cores, not shown), and the cores 61(A)-(N) being one or more general purpose cores (e.g., general purpose in-order cores, general purpose out-of-order cores, or a combination of the two); 2) a coprocessor with the cores 61(A)-(N) being a large number of special purpose cores intended primarily for graphics and/or scientific (throughput); and 3) a coprocessor with the cores 61(A)-(N) being a large number of general purpose in-order cores. Thus, the processor 60 can be a general-purpose processor, coprocessor or special-purpose processor, such as, for example, a network or communication processor, compression engine, graphics processor, GPGPU (general purpose graphics processing unit), a high throughput many integrated core (MIC) coprocessor (including 30 or more cores), embedded processor, or the like. The processor 60 can be implemented on one or more chips. The processor 60 can be a part of and/or can be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 62(A)-(N) within the cores 61(A)-(N), a set of one or more shared cache unit(s) circuitry 63, and external memory (not shown) coupled to the set of integrated memory controller unit(s) circuitry 67. The set of one or more shared cache unit(s) circuitry 63 can include one or more mid-level caches, such as level 2 (L2), level 3 (L3), level 4 (L4), or other levels of cache, such as a last level cache (LLC), and/or combinations thereof. While in some examples interface network circuitry 66 (e.g., a ring interconnect) interfaces the special purpose logic 64 (e.g., integrated graphics logic), the set of shared cache unit(s) circuitry 63, and the system agent unit circuitry 65, alternative examples use any number of well-known techniques for interfacing such units. In some examples, coherency is maintained between one or more of the shared cache unit(s) circuitry 63 and cores 61(A)-(N). In some examples, interface controller units circuitry 68 couple the cores 61 to one or more other devices 69 such as one or more I/O devices, storage, one or more communication devices (e.g., wireless networking, wired networking, etc.), etc.

In some examples, one or more of the cores 61(A)-(N) are capable of multi-threading. The system agent unit circuitry 65 includes those components coordinating and operating cores 61(A)-(N). The system agent unit circuitry 65 can include, for example, power control unit (PCU) circuitry and/or display unit circuitry (not shown). The PCU can be or can include logic and components needed for regulating the power state of the cores 61(A)-(N) and/or the special purpose logic 64 (e.g., integrated graphics logic). The display unit circuitry is for driving one or more externally connected displays.

The cores 61(A)-(N) can be homogenous in terms of instruction set architecture (ISA). Alternatively, the cores 61(A)-(N) can be heterogeneous in terms of ISA; that is, a subset of the cores 61(A)-(N) can be capable of executing an ISA, while other cores can be capable of executing only a subset of that ISA or another ISA.

Embodiments of each of the above systems, devices, components and/or methods, including the system 10, the semiconductor apparatus 30, the VR 300, the VR controller 310, the VR 400, the VR controller 405, the VR 420, the VR controller 425, the VR 440, and/or the VR controller 445, the method 500, and/or any other system components, can be implemented in hardware, software, or any suitable combination thereof. For example, hardware implementations can include configurable logic such as, for example, programmable logic arrays (PLAs), field programmable gate arrays (FPGAs), complex programmable logic devices (CPLDs), or fixed-functionality logic hardware using circuit technology such as, for example, application specific integrated circuit (ASIC), general purpose microprocessor or TTL technology, or any combination thereof. Moreover, the configurable and/or fixed-functionality hardware can be implemented via CMOS technology.

Alternatively, or additionally, all or portions of the foregoing systems and/or components and/or methods can be implemented in one or more modules as a set of logic instructions stored in a machine- or computer-readable storage medium such as random access memory (RAM), read only memory (ROM), programmable ROM (PROM), firmware, flash memory, etc., to be executed by a processor or computing device. For example, computer program code to carry out the operations of the components can be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages.

### ADDITIONAL NOTES AND EXAMPLES

Example V1 includes a voltage regulator controller comprising one or more substrates, and logic coupled to the one or more substrates, wherein the logic is implemented at least partly in one or more of configurable logic or fixed-functionality hardware logic, the logic to generate a first set of control signals to control current in one or more coupled inductor pairs in a voltage regulator (VR) circuit, wherein the control signals for each coupled inductor pair operate at a first frequency representing a base operation frequency of each coupled inductor phase, and generate a second control signal at a second frequency to control current in an uncoupled inductor in the VR circuit, wherein the second frequency is set relative to the first frequency to control ripple in an output current of the VR circuit, wherein the first set of control signals and the second control signal represent, in combination, an odd phase count.

Example V2 includes the voltage regulator controller of Example V1, wherein the second frequency is set based on the first frequency and on a number of coupled inductor pairs in the VR circuit.

Example V3 includes the voltage regulator controller of Example V1 or V2, wherein the second frequency is set to a value approximately equal to 2N times the first frequency, wherein N is the number of coupled inductor pairs in the VR circuit.

Example V4 includes the voltage regulator controller of Example V1, V2 or V3, wherein the logic is further to set a phase shift of the second control signal relative to a first phase of one of the first set of control signals to further control the ripple in the output current of the VR circuit.

Example V5 includes the voltage regulator controller of any of Examples V1-V4, wherein the phase shift of the second control signal is set based on one or more of a duty cycle of the VR circuit, an inductance of the uncoupled inductor, or a leakage inductance of one of the coupled inductor pairs.

Example V6 includes the voltage regulator controller of any of Examples V1-V5, wherein the phase shift of the second control signal is set to a value approximately equal to 180 degrees times (1+D), wherein D is the duty cycle of the VR circuit.

Example V7 includes the voltage regulator controller of any of Examples V1-V6, wherein the phase shift of the second control signal is based on the inductance of the uncoupled inductor exceeding a threshold inductance, and wherein the threshold inductance is based on the duty cycle of the VR circuit and the leakage inductance of one of the coupled inductor pairs.

Example V8 includes the voltage regulator controller of any of Examples V1-V7, wherein the inductance of the uncoupled inductor is a value approximately three times the threshold inductance.

Example V9 includes the voltage regulator controller of any of Examples V1-V8, wherein an output of the uncoupled inductor is electrically coupled to an output of each of the one or more coupled inductor pairs.

Example R1 includes a voltage regulator comprising one or more coupled inductor pairs, an uncoupled inductor, wherein an output of the uncoupled inductor is electrically coupled to an output of each of the one or more coupled inductor pairs, and a control circuit comprising logic implemented at least partly in one or more of configurable logic or fixed-functionality hardware logic, the logic to generate a first set of control signals to control current in one or more coupled inductor pairs in a voltage regulator (VR) circuit, wherein the control signals for each coupled inductor pair operate at a first frequency representing a base operation frequency of each coupled inductor phase, generate a second control signal at a second frequency to control current in an uncoupled inductor in the VR circuit, wherein the second frequency is set relative to the first frequency to control ripple in an output current of the VR circuit, and set a phase shift of the second control signal relative to a first phase of one of the first set of control signals to further control the ripple in the output current of the VR circuit, wherein the first set of control signals and the second control signal represent, in combination, an odd phase count.

Example R2 includes the voltage regulator of Example R1, wherein the second frequency is set based on the first frequency and on a number of coupled inductor pairs in the VR circuit.

Example R3 includes the voltage regulator of Example R1 or R2, wherein the second frequency is set to a value approximately equal to 2N times the first frequency, wherein N is the number of coupled inductor pairs in the VR circuit.

Example R4 includes the voltage regulator of Example R1, R2 or R3, wherein the logic is further to set a phase shift of the second control signal relative to a first phase of one of the first set of control signals to further control the ripple in the output current of the VR circuit.

Example R5 includes the voltage regulator of any of Examples R1-R4, wherein the phase shift of the second control signal is set based on one or more of a duty cycle of the VR circuit, an inductance of the uncoupled inductor, or a leakage inductance of one of the coupled inductor pairs.

Example R6 includes the voltage regulator of any of Examples R1-R5, wherein the phase shift of the second control signal is set to a value approximately equal to 180 degrees times (1+D), wherein D is the duty cycle of the VR circuit.

Example R7 includes the voltage regulator of any of Examples R1-R6, wherein the inductance of the uncoupled inductor exceeds a threshold inductance, and wherein the threshold inductance is based on the duty cycle of the VR circuit and the leakage inductance of one of the coupled inductor pairs.

Example R8 includes the voltage regulator of any of Examples R1-R7, wherein the inductance of the uncoupled inductor is a value approximately three times the threshold inductance.

Example A1 includes a semiconductor apparatus comprising one or more substrates, a processor coupled to the one or more substrates, a voltage regulator circuit coupled to the processor, the voltage regulator circuit comprising one or more coupled inductor pairs and an uncoupled inductor, wherein an output of the uncoupled inductor is electrically coupled to an output of each of the one or more coupled inductor pairs, and logic coupled to the one or more substrates, wherein the logic is implemented at least partly in one or more of configurable logic or fixed-functionality hardware logic, the logic to generate a first set of control signals to control current in one or more coupled inductor pairs in a voltage regulator (VR) circuit, wherein the control signals for each coupled inductor pair operate at a first frequency representing a base operation frequency of each coupled inductor phase, generate a second control signal at a second frequency to control current in an uncoupled inductor in the VR circuit, wherein the second frequency is set relative to the first frequency to control ripple in an output current of the VR circuit, and set a phase shift of the second control signal relative to a first phase of one of the first set of control signals to further control the ripple in the output current of the VR circuit, wherein the first set of control signals and the second control signal represent, in combination, an odd phase count.

Example A2 includes the apparatus of Example A1, wherein the second frequency is set based on the first frequency and on a number of coupled inductor pairs in the VR circuit.

Example A3 includes the apparatus of Example A1 or A2, wherein the second frequency is set to a value approximately equal to 2N times the first frequency, wherein N is the number of coupled inductor pairs in the VR circuit.

Example A4 includes the apparatus of Example A1, A2 or A3, wherein the logic is further to set a phase shift of the second control signal relative to a first phase of one of the first set of control signals to further control the ripple in the output current of the VR circuit.

Example A5 includes the apparatus of any of Examples A1-A4, wherein the phase shift of the second control signal is set based on one or more of a duty cycle of the VR circuit, an inductance of the uncoupled inductor, or a leakage inductance of one of the coupled inductor pairs.

Example A6 includes the apparatus of any of Examples A1-A5, wherein the phase shift of the second control signal is set to a value approximately equal to 180 degrees times (1+D), wherein D is the duty cycle of the VR circuit.

Example A7 includes the apparatus of any of Examples A1-A6, wherein the inductance of the uncoupled inductor exceeds a threshold inductance, and wherein the threshold inductance is based on the duty cycle of the VR circuit and the leakage inductance of one of the coupled inductor pairs.

Example A8 includes the apparatus of any of Examples A1-A7, wherein the inductance of the uncoupled inductor is a value approximately three times the threshold inductance.

Example M1 includes a method of controlling a voltage regulator, comprising generating a first set of control signals to control current in one or more coupled inductor pairs in a voltage regulator (VR) circuit, wherein at the control signals for each coupled inductor pair operate at a first frequency representing a base operation frequency of each coupled inductor phase, and generating a second control signal at a second frequency to control current in an uncoupled inductor in the VR circuit, wherein the second frequency is set relative to the first frequency to control ripple in an output current of the VR circuit.

Example M2 includes the method of Example M1, wherein the second frequency is set based on the first frequency and on a number of coupled inductor pairs in the VR circuit.

Example M3 includes the method of Example M1 or M2, wherein the second frequency is set to a value approximately equal to 2N times the first frequency, wherein N is the number of coupled inductor pairs in the VR circuit.

Example M4 includes the method of Example M1, M2 or M3, wherein the logic is further to set a phase shift of the second control signal relative to a first phase of one of the first set of control signals to further control the ripple in the output current of the VR circuit.

Example M5 includes the method of any of Examples M1-M4, wherein the phase shift of the second control signal is set based on one or more of a duty cycle of the VR circuit, an inductance of the uncoupled inductor, or a leakage inductance of one of the coupled inductor pairs.

Example M6 includes the method of any of Examples M1-M5, wherein the phase shift of the second control signal is set to a value approximately equal to 180 degrees times (1+D), wherein D is the duty cycle of the VR circuit.

Example M7 includes the method of any of Examples M1-M6, wherein the inductance of the uncoupled inductor exceeds a threshold inductance, and wherein the threshold inductance is based on the duty cycle of the VR circuit and the leakage inductance of one of the coupled inductor pairs.

Example M8 includes the method of any of Examples M1-M7, wherein the inductance of the uncoupled inductor is a value approximately three times the threshold inductance.

Embodiments are applicable for use with all types of semiconductor integrated circuit (“IC”) chips. Examples of these IC chips include but are not limited to processors, controllers, chipset components, PLAs, memory chips, network chips, systems on chip (SoCs), SSD/NAND controller ASICs, and the like. In addition, in some of the drawings, signal conductor lines are represented with lines. Some can be different, to indicate more constituent signal paths, have a number label, to indicate a number of constituent signal paths, and/or have arrows at one or more ends, to indicate primary information flow direction. This, however, should not be construed in a limiting manner. Rather, such added detail can be used in connection with one or more exemplary embodiments to facilitate easier understanding of a circuit. Any represented signal lines, whether or not having additional information, can actually comprise one or more signals that can travel in multiple directions and can be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature overtime, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections, including logical connections via intermediate components (e.g., device A may be coupled to device C via device B). In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

1. A voltage regulator controller comprising:
one or more substrates; and
logic coupled to the one or more substrates, wherein the logic is implemented at least partly in one or more of configurable logic or fixed-functionality hardware logic, the logic to:
generate a first set of control signals to control current in one or more coupled inductor pairs in a voltage regulator (VR) circuit, wherein the control signals for each coupled inductor pair operate at a first frequency representing a base operation frequency of each coupled inductor phase; and
generate a second control signal at a second frequency to control current in an uncoupled inductor in the VR circuit, wherein the second frequency is set relative to the first frequency to control ripple in an output current of the VR circuit;
wherein the first set of control signals and the second control signal represent, in combination, an odd phase count.

2. The voltage regulator controller of claim 1, wherein the second frequency is set based on the first frequency and on a number of coupled inductor pairs in the VR circuit.

3. The voltage regulator controller of claim 2, wherein the second frequency is set to a value approximately equal to 2N times the first frequency, wherein N is the number of coupled inductor pairs in the VR circuit.

4. The voltage regulator controller of claim 3, wherein the logic is further to set a phase shift of the second control signal relative to a first phase of one of the first set of control signals to further control the ripple in the output current of the VR circuit.

5. The voltage regulator controller of claim 4, wherein the phase shift of the second control signal is set based on one or more of a duty cycle of the VR circuit, an inductance of the uncoupled inductor, or a leakage inductance of one of the coupled inductor pairs.

6. The voltage regulator controller of claim 5, wherein the phase shift of the second control signal is set to a value approximately equal to 180 degrees times (1+D), wherein D is the duty cycle of the VR circuit.

7. A voltage regulator comprising:
one or more coupled inductor pairs;
an uncoupled inductor, wherein an output of the uncoupled inductor is electrically coupled to an output of each of the one or more coupled inductor pairs; and
a control circuit comprising logic implemented at least partly in one or more of configurable logic or fixed-functionality hardware logic, the logic to:
generate a first set of control signals to control current in one or more coupled inductor pairs in a voltage regulator (VR) circuit, wherein the control signals for each coupled inductor pair operate at a first frequency representing a base operation frequency of each coupled inductor phase;
generate a second control signal at a second frequency to control current in an uncoupled inductor in the VR circuit, wherein the second frequency is set relative to the first frequency to control ripple in an output current of the VR circuit; and
set a phase shift of the second control signal relative to a first phase of one of the first set of control signals to further control the ripple in the output current of the VR circuit;
wherein the first set of control signals and the second control signal represent, in combination, an odd phase count.

8. The voltage regulator of claim 7, wherein the second frequency is set based on the first frequency and on a number of coupled inductor pairs in the VR circuit.

9. The voltage regulator of claim 8, wherein the second frequency is set to a value approximately equal to 2N times the first frequency, wherein N is the number of coupled inductor pairs in the VR circuit.

10. The voltage regulator of claim 9, wherein the logic is further to set a phase shift of the second control signal relative to a first phase of one of the first set of control signals to further control the ripple in the output current of the VR circuit.

11. The voltage regulator of claim 10, wherein the phase shift of the second control signal is set based on one or more of a duty cycle of the VR circuit, an inductance of the uncoupled inductor, or a leakage inductance of one of the coupled inductor pairs.

12. The voltage regulator of claim 11, wherein the phase shift of the second control signal is set to a value approximately equal to 180 degrees times (1+D), wherein D is the duty cycle of the VR circuit.

13. The voltage regulator of claim 12, wherein the inductance of the uncoupled inductor exceeds a threshold inductance, and wherein the threshold inductance is based on the duty cycle of the VR circuit and the leakage inductance of one of the coupled inductor pairs.

14. The voltage regulator of claim 13, wherein the inductance of the uncoupled inductor is a value approximately three times the threshold inductance.

15. A semiconductor apparatus comprising:
one or more substrates;
a processor coupled to the one or more substrates;
a voltage regulator circuit coupled to the processor, the voltage regulator circuit comprising one or more coupled inductor pairs and an uncoupled inductor, wherein an output of the uncoupled inductor is electrically coupled to an output of each of the one or more coupled inductor pairs; and
logic coupled to the one or more substrates, wherein the logic is implemented at least partly in one or more of configurable logic or fixed-functionality hardware logic, the logic to:
generate a first set of control signals to control current in one or more coupled inductor pairs in a voltage regulator (VR) circuit, wherein the control signals for each coupled inductor pair operate at a first frequency representing a base operation frequency of each coupled inductor phase;
generate a second control signal at a second frequency to control current in an uncoupled inductor in the VR circuit, wherein the second frequency is set relative to the first frequency to control ripple in an output current of the VR circuit; and
set a phase shift of the second control signal relative to a first phase of one of the first set of control signals to further control the ripple in the output current of the VR circuit;
wherein the first set of control signals and the second control signal represent, in combination, an odd phase count.

16. The apparatus of claim 15, wherein the second frequency is set based on the first frequency and on a number of coupled inductor pairs in the VR circuit.

17. The apparatus of claim 16, wherein the second frequency is set to a value approximately equal to 2N times the first frequency, wherein N is the number of coupled inductor pairs in the VR circuit.

18. The apparatus of claim 17, wherein the logic is further to set a phase shift of the second control signal relative to a first phase of one of the first set of control signals to further control the ripple in the output current of the VR circuit.

19. The apparatus of claim 18, wherein the phase shift of the second control signal is set based on one or more of a duty cycle of the VR circuit, an inductance of the uncoupled inductor, or a leakage inductance of one of the coupled inductor pairs.

20. The apparatus of claim 19, wherein the phase shift of the second control signal is set to a value approximately equal to 180 degrees times (1+D), wherein D is the duty cycle of the VR circuit.
